(19) United States
(12) Patent Application Publication
(10) Pub. No.: US 2016/0371708 A1
(43) Pub. Date: Dec. 22, 2016

(54) METHOD AND APPARATUS FOR DETERMINING A USER'S LEVEL OF INTEREST IN WEB-BASED CONTENT

(71) Applicant: Lenovo Enterprise Solutions (Singapore) Pte. Ltd., Singapore (SG)

(72) Inventors: Po Ya Chuang, New Taipei City (TW); Wan Ping Ting, Taipei (TW); Sheng Han Tsai, New Taipei City (TW)

(21) Appl. No.: 15/183,894

(22) Filed: Jun. 16, 2016

(30) Foreign Application Priority Data
Jun. 19, 2015 (CN) 2015103455817

(51) Int. Cl. G06Q 30/02; G06F 3/0484

(52) U.S. Cl. CPC G06Q 30/0201; G06F 3/0484; G06F 2203/04803

(57) ABSTRACT

A computer-implemented method and a computer program product are provided for determining a user's level of interest in a content item during browsing of a plurality of content items. The method includes sequentially displaying a plurality of content items on a screen of a display device as a user interacts with a web-browser application, detecting a display time associated with each content item, wherein the display time is a duration for which the content item is displayed on the screen of the display device, and determining, for each of the plurality of content items displayed, a level of interest as a function of the display time associated with the content item.

### CROSS-REFERENCE TO RELATED APPLICATION

This application claims priority under 35 U.S.C. §119 to Chinese Patent Application No. 2015103455817 filed Jun. 19, 2015, the entire text of which is specifically incorporated by reference herein.

### BACKGROUND

Field of the Invention

The present invention relates to methods and apparatus for determining an individual user's interest in online content.

Background of the Related Art

An individual may use a computer running a web browser to search for and view a variety of online content, such as websites, video, blogs, social media, retailers, and an every expanding offering of content and services. A determination of an individual's interests can provide information that is valuable for the purpose of generating advertisements or other recommended materials.

Currently, advertisements or content recommendations are placed so as to reach human subjects (e.g. web users) based on a prediction of the user's interests. The prediction may be based on a user's history of interactions with related web-based content. For example, targeted advertisements may be generated and delivered to the user based on a search performed by the user, a webpage visited or other sources of information accessed by the user in the past. However, the advertisements and content recommendations generated in this manner may be rather limited and may be rendered obsolete over time, since they are based on the user's historical actions.

### BRIEF SUMMARY

One embodiment of the present invention provides a computer-implemented method, comprising sequentially displaying a plurality of content items on a screen of a display device as a user interacts with a web-browser application, detecting a display time associated with each content item, wherein the display time is a duration for which the content item is displayed on the screen of the display device, and determining, for each of the plurality of content items displayed, a level of interest as a function of the display time associated with the content item.

Another embodiment of the present invention provides a computer program product comprising a non-transitory computer readable storage medium having program instructions embodied therewith, wherein the program instructions are executable by a processor to cause the processor to perform a method. The method comprises sequentially displaying a plurality of content items on a screen of a display device as a user interacts with a web-browser application, detecting a display time associated with each content item, wherein the display time is a duration for which the content item is displayed on the screen of the display device, and determining, for each of the plurality of content items displayed, a level of interest as a function of the display time associated with the content item.

### BRIEF DESCRIPTION OF THE SEVERAL VIEWS OF THE DRAWINGS

In order that the advantages of the various embodiments will be readily understood, a more particular description of the various embodiments briefly described above is provided by reference to specific exemplary embodiments that are illustrated in the accompanying drawings, which depict only exemplary embodiments and are not to be considered to be limiting in scope. The various embodiments are described and explained with additional specificity and detail through the use of the accompanying drawings.

FIG. 1 is a diagram of one example of a client-server network suitable for implementing one or more embodiments of the present invention.

FIG. 2 is a flowchart of a method according an embodiment of the present invention.

FIG. 3 is a block diagram of a computer system suitable for implementing one or more embodiments of the present invention.

FIG. 4 is a diagram of an interface displaying content items in a plurality of sub-regions of the interface.

FIG. 5 is a flowchart of an exemplary method of assessing a user's level of interest using browsing data.

FIG. 6 is a flowchart illustrating another embodiment of the present invention.

### DETAILED DESCRIPTION

One embodiment of the present invention provides a computer-implemented method, comprising sequentially displaying a plurality of content items on a screen of a display device as a user interacts with a web-browser application, detecting a display time associated with each content item, wherein the display time is a duration for which the content item is displayed on the screen of the display device, and determining, for each of the plurality of content items displayed, a level of interest as a function of the display time associated with the content item.

Another embodiment of the present invention provides a computer program product comprising a non-transitory computer readable storage medium having program instructions embodied therewith, wherein the program instructions are executable by a processor to cause the processor to perform a method. The method comprises sequentially displaying a plurality of content items on a screen of a display device as a user interacts with a web-browser application, detecting a display time associated with each content item, wherein the display time is a duration for which the content item is displayed on the screen of the display device, and determining, for each of the plurality of content items displayed, a level of interest as a function of the display time associated with the content item.

In general terms, there is provided a method and apparatus for determining a user's interest in web-based content using browsing data which is indicative of a duration for which a content item is viewable to the user. Accordingly, a plurality of content items are sequentially displayed on a screen of a display device as a user interacts with a web-browser application. The sequential display of content items may occur as a result of normal browsing, such as scrolling content items of a single page across the screen or moving between multiple pages of content items. The content items for which the display time is determined need not have been presented in an uninterrupted sequence, but may merely have been presented at different times. For example, the content items may be sequentially displayed during a single browser session or may be sequentially displayed over multiple browsers sessions, separated by periods of time where the browser is closed or becomes an inactive or minimized window. Furthermore, the display time for a content item may be determined over a plurality of browser sessions or over multiple viewings of the content item, such as by storing and accumulating total display time.

One embodiment provides a computer-implemented method for determining a user's interests in web-based content. The method comprises for each of content items delivered via a display device for viewing by the user, detecting, by a browsing-data detection component, browsing data indicative of a display time associated with said content item. The display time defines a duration for which said content item is viewable to the user on a screen of the display device and the browsing data is being used to assess the user's level of interest in the content item displayed.

The method may comprise displaying, by a content displaying component, the content items via the display device.

The assessed user's level of interest may be used to select an associated content item deemed to be of more interest and the associated content item being related contextually to at least one of the content items displayed.

The method may further comprise receiving, by a content processing component, the associated content item for displaying to the user.

The method may further comprise transmitting, by a browsing-data transmission component, content data associated with at least one of the content items identified using the browsing data, for selecting the associated content item.

The method may comprise transmitting the browsing data for a plurality of the content items to an interest identification system for assessing the user's level of interest in the content items displayed using the browsing data.

The method may comprise displaying, by a content presentation component, the associated content item to the user via the screen. The associated content item may be displayed to the user in real-time.

The method may further comprise detecting, by the browsing-data detection component, browsing data indicative of a display location of the content item with respect to an interface on which the content item is displayed. The interface may comprises a plurality of sub-regions and the method may comprise detecting the sub-region in which the content item is displayed. The sub-regions may be defined by delineating the interface parallel to a major dimension of the interface. In one example, the interface comprises a graphic user interface of a software application through which the content items are made available to the user. In another example, the interface is the screen of the display device.

The method may further comprise using a graphical control element of the software application to register a location at which the content item is displayed.

In one embodiment, the method comprises calculating, by an interest analysis component, a respective interest score representing the user's level of interest in the content items using the browsing data. The interest score may be calculated by obtaining a weight factor based on the display location, in which the weight factor is associated with the respective sub-region of the interface. Optionally, the interest score may be calculated using a weighted sum of the display time of the content item successively displayed in one or more of the sub-regions weighted by the corresponding weight factors for the respective sub-regions.

In one embodiment, a sub-set of the plurality of content items is identified by comparing the respective interest scores with a reference score and obtaining the associated content item using the sub-set of the content items.

In one embodiment, a determination is made as to whether the display time of the content item is above a pre-defined threshold, and if the determination is positive, the interest score is calculated for the content item.

In one embodiment, the web-based content comprises at least one of: (a) a blog; (b) news feeds (c) multi-media content and (d) text-based content.

The method may comprise activating a timer to calculate the display time for the respective content items upon displaying the content item via the display device.

Another embodiment provides an apparatus for determining a user's interests in web-based content. The apparatus comprises a computer processor and a data storage device, and the data storage device has a browsing-data detection component comprising non-transitory instructions operative by the processor to, for each of content items delivered via a display device for viewing by the user, detect browsing data indicative of a display time associated with said content item. The display time defines a duration for which said content item is viewable to the user on the screen and the browsing data is being used to assess the user's level of interest in the content item displayed. The data storage device may have other components comprising non-transitory instructions operative by the processor to perform other features of the method as disclosed above.

Yet another embodiment provides a non-transitory computer-readable medium for identifying a user's interests in web-based content. The computer-readable medium has stored thereon program instructions for causing at least one processor to, for each of content items delivered via a display device for viewing by the user, detect browsing data indicative of a display time associated with said content item. The display time defines a duration for which said content item is viewable to the user on the screen, and the browsing data is being used to assess the user's level of interest in the content item displayed. The computer-readable medium has stored thereon further program instructions for causing at least one processor to perform other features of the method as disclosed above.

A further embodiment provides another computer-implemented method for determining a user's interests in web-based content. The method comprises for each of content items delivered via a display device for viewing by the user, obtaining, by a browsing-data analysis component, browsing data indicative of a display time associated with said content item. The display time defines a duration for which said content item is viewable to the user on the screen. The method further comprises assessing, by an interest analysis component, the user's level of interest in the content item displayed using the browsing data.

The method may comprise further optional features outlined above with respect to another embodiment. For example, the method may comprise determining, by the interest analysis component, an associated content item deemed to be of more interest to the user using the assessed level of interest for delivery to the user, in which the associated content item is related to contextually to at least one of the content items displayed. For another example, the method may comprise delivering the associated content item for displaying via the display device in real-time.

A still further embodiment provides an apparatus for determining a user's interests in web-based content. The apparatus comprising a computer processor and a data storage device, the data storage device having a browsing-data analysis component and an interest analysis component comprising non-transitory instructions operative by the processor to, for each of content items delivered via a display device for viewing by the user, obtain browsing data indicative of a display time associated with said content item, said display time defining a duration for which said content item is viewable to the user on the screen, and assess the user's level of interest in the content item displayed using the browsing data.

The method may comprise further optional features outlined above with respect to various embodiments. It will be apparent to a skilled person in the art that features of different embodiments may be combined.

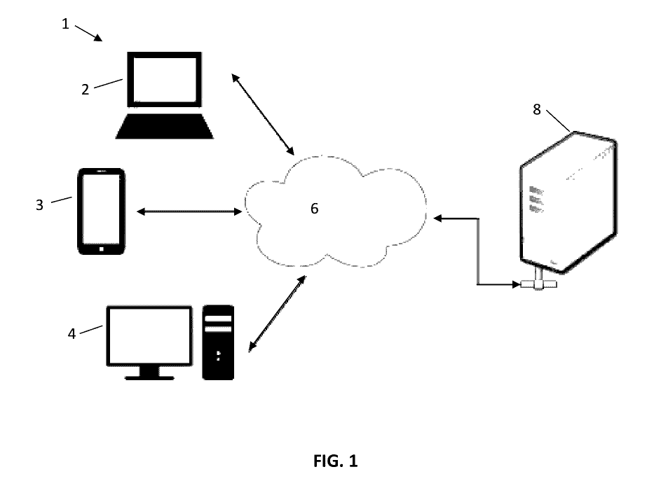

FIG. 1 illustrates a client-server network 1 comprising three client devices 2, 3, 4 connected via the Internet 6 to a server 8. The client device 2 is a laptop and a user may use software applications such as a web browser running on the laptop 2 to communicate with a content management system (not shown) from the Internet 6 to retrieve web-content provided by the server 8. The server 8 is accessible to a plurality of databases (not shown) containing web resources stored on the server 8 or otherwise in communication with the server 8. The web-content (such as text, images, audio, video or other content items) may be communicated to the user via rendering on a screen of the client device. For example, the content items are made viewable by the user via a graphic user interface of a software application running on the laptop 2. The second and third client devices, a mobile phone 3 and a desktop computer 4, may also be present to communicate with the server 8 via the Internet 6. Typically, the client devices 2, 3, 4 and the server 8 each have a computer processor capable of executing computer-readable instructions stored on a data storage device operatively coupled to the computer processor. It should be apparent that any number of client devices may be present in the client-server network 1 to communicate with the server 8 or multiple servers. The client device may be any electronic device which has a screen for displaying content items viewable by the user, such as, but not limited to, laptop computers, desktop computers, mobile phones, music players, GPS-enabled devices, tablet computers, and smart watches.

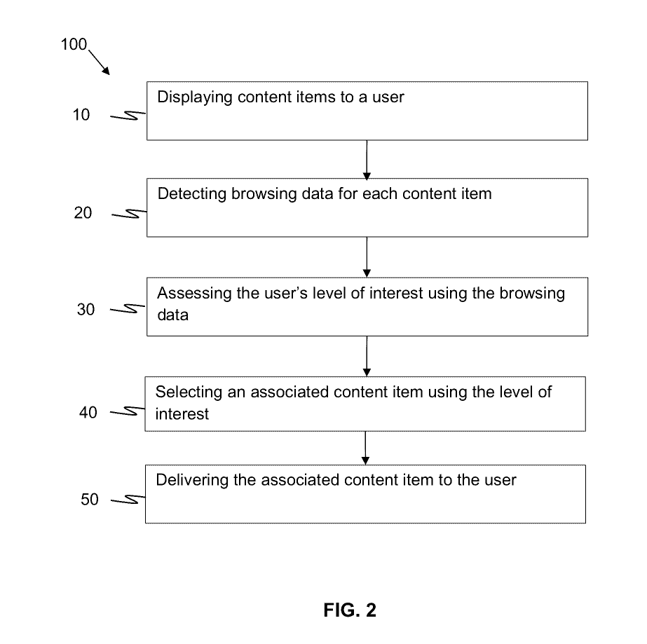

FIG. 2 is a flowchart of a method 100 for determining a user's level of interest in web-based content as will be described in detail later with reference to the laptop 2 of FIG. 1. The method 100 is implemented by an apparatus having a computer processor executing computer-readable instructions stored on a data storage device operatively coupled to the computer processor.

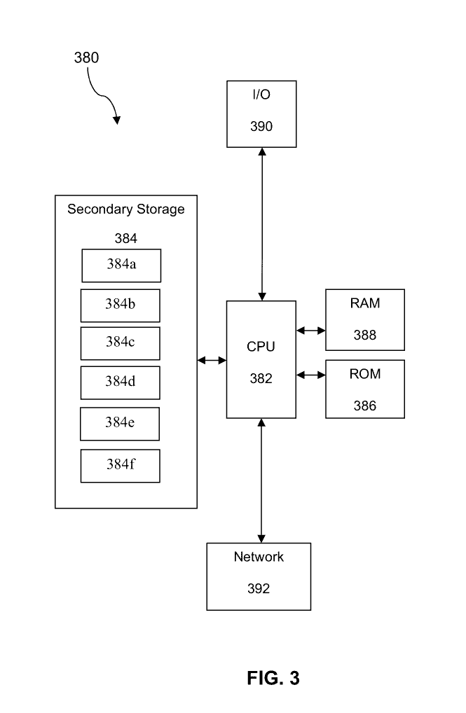

FIG. 3 illustrates a technical architecture 380 of the laptop 2 (of FIG. 1) which is suitable for implementing one or more embodiments disclosed herein. The technical architecture 380 includes a processor 382 (which may be referred to as a central processor unit or CPU) that is in communication with memory devices including a secondary data storage device 384 (such as disk drives), a read-only memory (ROM) device 386, a random access memory (RAM) device 388, an input/output (I/O) device 390, and a network connectivity device 392. The processor 382 may be implemented as one or more CPU chips.

The secondary storage 384 is typically comprised of one or more disk drives or tape drives and is used for non-volatile storage of data and as an over-flow data storage device if the RAM 388 is not large enough to hold all working data. The secondary storage 384 may be used to store programs which are loaded into RAM 388 when such programs are selected for execution. In this embodiment, the secondary storage 384 has a content displaying component 384a, a browsing-data detection component 384b, a browsing-data transmission component 384c, a content processing component 384d, a content presentation component 384e, and an interest analysis component 384f comprising non-transitory instructions operative by the processor 382 to perform various operations of the method of the present disclosure. The above components may optionally be integrated as a part (such as a plug-in/extension software) of bundled software of the computer system (such as the operating system), or another software application such as a web-browser, which enables customization. The above components may also be independently executable to cooperate with any software application to perform the method of the present disclosure. The ROM 386 is used to store instructions and perhaps data which are read during program execution. The secondary storage 384, the RAM 388, and/or the ROM 386 may be referred to in some contexts as computer readable storage media and/or non-transitory computer readable media.

I/O device 390 may represent any one or more I/O device including printers, video monitors, liquid crystal displays (LCDs), plasma displays, touch screen displays, keyboards, keypads, switches, dials, mice, track balls, voice recognizers, card readers, paper tape readers, or other well-known input devices.

The network connectivity device 392 may represent any one or more network connectivity device including modems, modem banks, Ethernet cards, universal serial bus (USB) interface cards, serial interfaces, token ring cards, fiber distributed data interface (FDDI) cards, wireless local area network (WLAN) cards, radio transceiver cards that promote radio communications using protocols such as code division multiple access (CDMA), global system for mobile communications (GSM), long-term evolution (LTE), worldwide interoperability for microwave access (WiMAX), near field communications (NFC), radio frequency identity (RFID), and/or other air interface protocol radio transceiver cards, and other well-known network devices. The one or more network connectivity device 392 may enable the processor 382 to communicate with the Internet or one or more intranets. With such a network connection, the processor 382 may receive information from the network, or may output information to the network in the course of performing the above-described method operations. Such information, which is often represented as a sequence of instructions to be executed by the processor 382, may be received from and outputted to the network, for example, in the form of a computer data signal embodied in a carrier wave.

The processor 382 executes instructions, codes, computer programs, and/or scripts which it accesses from a hard disk, floppy disk, optical disk (these various disk-based systems may all be considered secondary storage 384), flash drive, ROM 386, RAM 388, or the network connectivity device 392. While only one processor 382 is shown, multiple processors may be present. Thus, while instructions may be discussed as executed by a processor, the instructions may be executed simultaneously, serially, or otherwise executed by one or multiple processors.

Although the technical architecture 380 is described with reference to the laptop 2 of FIG. 1, it should be appreciated that the technical architecture may be formed by two or more computers in communication with each other that collaborate to perform a task. For example, but not by way of limitation, an application may be partitioned in such a way as to permit concurrent and/or parallel processing of the instructions of the application. Alternatively, the data processed by the application may be partitioned in such a way as to permit concurrent and/or parallel processing of different portions of a data set by the two or more computers. In an embodiment, virtualization software may be employed by the technical architecture 380 to provide the functionality of a number of servers that is not directly bound to the number of computers in the technical architecture 380. In an embodiment, the functionality disclosed above may be provided by executing the application and/or applications in a cloud computing environment. Cloud computing may comprise providing computing services via a network connection using dynamically scalable computing resources. A cloud computing environment may be established by an enterprise and/or may be hired on an as-needed basis from a third party provider.

It is understood that by programming and/or loading executable instructions onto the technical architecture 380, at least one of the CPU 382, the RAM 388, and the ROM 386 are changed, transforming the technical architecture 380 in part into a specific purpose machine or apparatus having the novel functionality taught by the present disclosure. It is fundamental to the electrical engineering and software engineering arts that functionality that can be implemented by loading executable software into a computer can be converted to a hardware implementation by well-known design rules.

It should be noted that various operations of the method 100 of FIG. 2, described below, may be performed by either of the client devices 2, 3, 4 or the server 8, but for the purpose of explanation, the laptop 2 will be used as an exemplary apparatus to perform the method 100. It should be noted that the enumeration of operations is for purposes of clarity and that the operations need not be performed in the order implied by the enumeration.

As shown in FIGS. 1-4, at operation 10, the content displaying component 384a is configured to cause the processor 382 of the laptop 2 to present the user with a plurality of web-based content items 200a, 200b, 200c, 200d, 200e, 200f, 200g, 200h, such as news items, via a display screen 202 of the laptop 2. Typically, the list of web-based content items 200a, 200b, 200c, 200d, 200e, 200f, 200g, 200h are viewed through a graphic user interface 204 of a software application such as a web-browser which retrieves and presents web-content to the user. Each of the web-based content items 200a, 200b, 200c, 200d, 200e, 200f, 200g, 200h is displayed at a respective location of a web-page for viewing by the user on the screen 202. The plurality of web-based content items may be retrieved by the user voluntarily, for example, from a content management system (e.g. a website), or pushed to the laptop 2 without requiring a user to initiate a request for retrieving such content items. Usually, each content item represents an individual piece of information, such as a news headline, news abstract, a post/thread, a picture, an indexing term or any other form of information field.

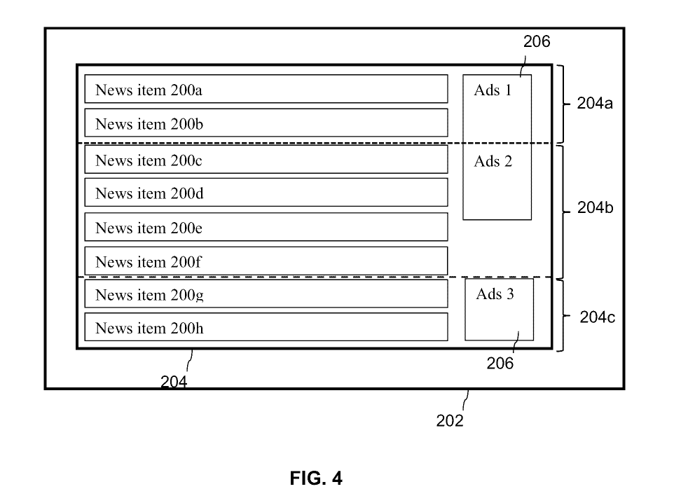

As shown in the example of FIG. 4, the interface 204 is defined by three sub-regions 204a, 204b, 204c respectively located on the top, middle and bottom sections of the interface 204. In other words, the three sub-regions 204a, 204b, 204c are delineated by dividing the interface 204 parallel to a major dimension (i.e. a width dimension in this case, as compared to a height dimension) of the interface 204. As shown in FIG. 4, the content items 200a, 200b are currently displayed on the sub-region 204a, the content items 200c, 200d, 200e, 200f are displayed on the sub-region 204b, and the content items 200g, 200h are displayed on the sub-region 204c. When the user's input is registered to scroll up and/or down the webpage, the display location of each content item with respect to the interface 204 changes and the content item may consequently be shifted to be displayed in another sub-region, or may even be shifted out of the screen 202 or the interface 204.

At operation 20, browsing data for each of the content items 200a, 200b, 200c, 200d, 200e, 200f, 200g, 200h is determined by the browsing-data detection component 384b. In one embodiment, a display time which defines a duration for which the content item is viewable on the screen by the user is determined. The display time may be determined by activating a timer upon initially displaying the content item via the laptop 2. The timer may be paused upon the content item being scrolled or otherwise displaced out of the screen 202 of the laptop 2 or out of the interface 204 of the software application. In one example, the timer may be deactivated when the content displaying component 384a is running only in the background (e.g. when it is not operational to register a user's input).

In another example, the display location of each of the content items with respect to the interface 204 is also determined by the browsing-data detection component 384b. For example, it is determined, for each of the content items, which sub-region of interface 204 the content item is associated with, or displayed on. Alternatively, the display location or the sub-region is determined with respect to the screen 202. The browsing-data detection component 284b may be implemented as a functional component of the web-browser or as any bundled software associated therewith, such as a plug-in or extension of the browser. In one example, a graphical control element (such as a scroll bar) of the software application is used to register a location at which the news item is displayed. The browsing data is determined and stored for processing by a computer processor to assess the user's level of interest in one or more of the content items.

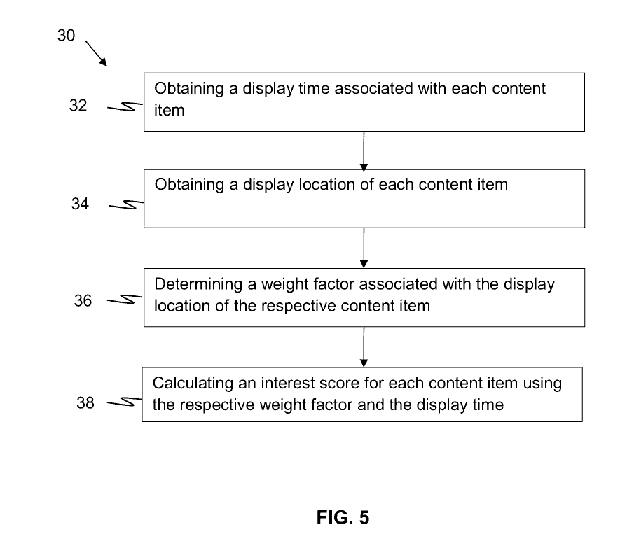

At operation 30, the user's level of interest in the one or more displayed content items is assessed using the browsing data by the interest analysis component 384f. In one example, the browsing data may be transmitted by the browsing-data transmission component 384c to an interest identification system (for example, a software or hardware component of the server 8) for performing the assessment. Alternatively, the assessment may be performed by the processor 382 of the laptop 2. Referring to FIG. 5, the operation 30 may comprise a plurality of sub-operations 32, 34, 36, 38. At operations 32, 34, the display time and the display location are obtained for each content item and an interest score is calculated.

In one example, each sub-region 204a, 204b, 204c of the interface 204 is assigned a weight factor representing the likelihood that the one or more content items displaying in this particular sub-region are the target content on which the user's attention is focused, while the content items on the entire screen are viewable to the user. For example, the sub-region 204b, which is located at the center of the screen 202 or the interface 204, is typically assigned a higher weight than the sub-regions 204a, 204c, which are located near the periphery of the screen 202 or interface 204. At operation 36, each of the content items is associated with a weight factor corresponding to the sub-region associated with its display location. This is consistent with habitual behavior of general users or readers, since typical readers tend to focus their views towards content items displayed in the central part of the screen 202. For example, even if each of the content items 200a, 200b, 200c, 200d, 200e, 200f, 200g, 200h are displayed on the screen 202 for the same amount of time, it is more likely that the user is focused to review some or all of the content items 200c, 200d, 200e, 200f, instead of content items 200a, 200b, 200g, 200h. At operation 38, an interest score for one or more content item is calculated using the respective weight factor and the display time. This allows the user's interest to be identified more closely and accurately based on the interest score, without requiring a user's explicit indication of his/her interest, such as clicking into a particular content item. In other words, no active user input or intervention is required apart from what is required of the user to browse through the content items that are being displayed on the screen 202. The interest score may be updated periodically, or in real-time based on the user's browsing behavior, as will be explained below.

In another example, the sub-regions are delineated or segregated by dividing the screen both horizontally and vertically into a plurality of blocks. Typically, the blocks or sub-regions closer to the users' area of focus are assigned with a higher weight while the blocks or sub-regions further away from the area of focus are assigned with a lower weight. For example, a block at the central portion of the screen 202 is assigned a weight factor from 0.7 to 0.9 while a block near the periphery of the screen is assigned a weight factor from 0.1 to 0.3. The delineation of sub-regions may depend on various factors, for example, the size (e.g. the display area) of the screen 202, the nature of the web-content, the amount of content items, and the type of display devices. The delineation of sub-regions and/or assignment of weight factors to the respective sub-regions may be determined by adaptive models trained to achieve the optimal results. In one example, the delineation may be dynamic, which means that the sub-regions and their associated weight factors may be modified over time. For example, a more detailed delineation of sub-regions may be used if there is a large number of content items being displayed on the screen at a certain time point.

In yet another example, the interest score may be calculated using a weighted sum of the display time of the content item successively displayed in one or more of the sub-regions weighted by the corresponding weight factors assigned to the respective sub-regions. In particular, the interest score P for a content item i may be calculated by the following equation:

Pᵢ=Σₙ₌₁^{m}tₙ×Wₙ,

where: n denotes a sub-region;
m denotes the total number of sub-regions;
tₙ, denotes the display time of the content item i in the sub-region n; and
Wₙ denotes the weight factor associated with the sub-region n.

For a plurality of content items i=1, 2, 3, . . . q delivered to the user, a respective interest score Pᵢ is calculated to identify a sub-set of the plurality of content items which are deemed to be of more interest to the user than other content items. The sub-set of the plurality of the content items may be identified by comparing the interest scores with a threshold, such as a reference score P₀. For example, if it is determined that Pᵢ>P₀, then it may be deemed that the user is interested in the content item i. Otherwise, if it is determined that Pᵢ<P₀, then it may be deemed that the user is not interested in the content item i.

In one embodiment, a display time tᵢ associated with a content item i is compared against a pre-defined threshold value t₀ before calculating an interest score for the content item. For example, if the display time tᵢ is determined to be below the threshold value t₀, no interest score is calculated for that content item, and an interest score is calculated if the display time tᵢ is determined to meet or exceed the threshold value t₀. This may allow the computation load of the processor to be reduced by omitting the interest score calculations for content items which are only displayed transiently (i.e. which are displaced out of the screen or interface very fast), since in that case it is very likely that the user has no interest in those items. Similarly, in another embodiment, a speed at which the user is scrolling up/down the webpage (and the corresponding content items) is detected, and if the detected speed exceeds a certain value then no interest score will be calculated for those content items. In a further embodiment, these content items (i.e., tᵢ<t₀) may be deemed to be of the least interest to the user and may be used as the basis for modifying future content items to be delivered to the user. For example, future content items which are contextually similar to these content items may be withheld from delivery to the user. This may improve the user's experience in browsing web-content since information that is irrelevant or uninteresting to the user can be filtered automatically, i.e. without requiring an active and explicit indication from the user. At the same time, this filtering of content items helps minimize inefficient use of Internet resources resulting from delivering redundant and untargeted information to the users.

It will be understood that an interest score may also be calculated without using the display location of the content item. For example, in the case that a display location of the content item is not detected, or is otherwise unavailable, an interest score may be determined based on the display time of the content item anywhere on the screen. In one embodiment, if the screen of the user's device displays only one or a few related content items at one time (for example, each page of a shopping catalogue that contains content items on successive pages for the user to flip through), then the user's level of interest in the content items may be inferred by the amount of time he/she stays on a particular page, without requiring the display location of the content items to be detected or used. Accordingly, it may not be necessary to detect the display location and/or using the display location for assessing the user's level of interest in the content items.

Furthermore, if the assessment of the user's level of interest is performed by the client device, no browsing data or interest scores are required to be communicated to the server 8. Instead, content data associated with the content item which is identified to have a high level of interest to the user may be transmitted to the server 8 for selecting the associated content item. Content data may comprise any data which characterizes the content items. For example, in such cases, the keywords associated with a content item may be sent from the client device to the server requesting additional content items associated with the same or similar keywords.

At operation 40, an associated content item which is determined to be of interest to the user is selected based on the assessed user's level of interest. The associated content item may be selected from a database containing web-content stored on the server 8. The selected associated content item may be related contextually to the content items displayed. In one embodiment, the associated content item is selected based on a content item which has one of the highest interest scores for the user. For example, the two content items are related to each other by a common indexing term such as a common keyword.

At operation 50, the associated content item that has been selected is delivered by the content processing component 384d for viewing by the user. The associated content item may be delivered immediately after the user's level of interest in the content items has been identified. In practice, this may allow recommended material to be displayed to the user in real time, that is, simultaneously or almost simultaneously when the user is viewing the content items based on which the recommended material has been selected. The recommended material (which includes the associated content items) may be displayed by the content presentation component 384e via a recommended content panel 206 located in a portion of the screen next to the region displaying the content item. This not only enhances user experiences by providing users with additional information of interest in real time, but also increases business revenue by correctly identifying potential customers as well as delivering targeted information to the user in a timely manner (e.g. within a time window of the user's attention span).

In one example, the associated content items are displayed to the user at a later time and/or through another device. For example, a user's interest is assessed based on a high level of interest in content items displayed on a user's mobile phone, and recommendations comprising the selected associated items are delivered to a tablet or a laptop associated with the same user, even when the user accesses the devices only at a later time.

In another example, the associated content items are arranged to be displayed to the user via a software application which is different from the one via which the initial content items were displayed. For example, the user's level of interest is assessed based on news items which are displayed by a social media application, such as Facebook™, while the associated content items such as advertisements, are delivered and displayed to the user via a web-browser, such as Internet Explorer™ or Google Chrome™.

In yet another example, it is possible that no associated content items may be selected or delivered to the user. Instead, the user's level of interest in the content items may be merely identified for statistical or other data collection purposes.

Although many operations described above are illustrated with respect to the client device, such as the laptop 2, some of the operations may be performed by the server 8. For example, the server 8 may have a computer processor and a data storage device having a browsing-data analysis component comprising non-transitory instructions operative by the processor to obtain browsing data from the client device, and further may have an interest analysis component comprising non-transitory instructions operative by the processor to use the browsing data to assess the user's level of interest in the content item displayed.

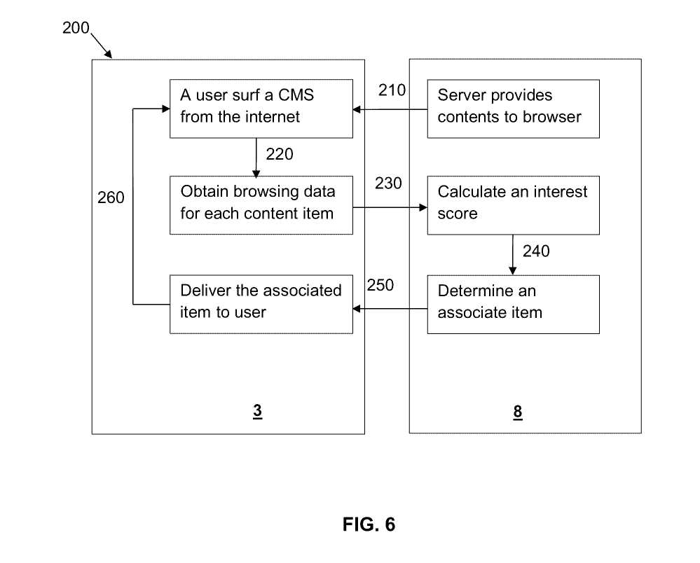

FIG. 6 illustrates another process 200 performed by the client device (for example, the mobile phone 3) and the server 8 over the client-server network 1 of FIG. 1. At operation 210, a server 8 is configured to provide web-based content to a browser running on a mobile phone 3 of the user. A content displaying component 384a of the mobile phone 3 enables the user to view the content items via a content management system (CMS) from the Internet. At operation 220, a browsing-data detection component 384b of the mobile phone 3 obtains the display time and display location for each of the displayed content items. The browsing-data is then transmitted at operation 230, by a browsing-data transmission component 384c, to the server 8.

Upon the server 8 obtaining the browsing data by a browsing-data analysis component, an interest score is calculated for each of the content items using an interest analysis component 384f. At operation 240, one or more associated content items which are deem to be of a high level of interest to the user is selected by the server 8. At operation 250, the associated content items are delivered to the mobile phone 3 which is configured to receive the content by a content processing component 384d. At operation 260, a content presentation component 384e causes the mobile phone 3 to display the associated content items via its screen for viewing by the user.

In an embodiment, some or all of the functionality disclosed above may be provided as a computer program product. The computer program product may comprise one or more computer readable storage medium having computer usable program code embodied therein to implement the functionality disclosed above. The computer program product may comprise data structures, executable instructions, and other computer usable program code. The computer program product may be embodied in removable computer storage media and/or non-removable computer storage media. The removable computer readable storage medium may comprise, without limitation, a paper tape, a magnetic tape, magnetic disk, an optical disk, a solid state memory chip, for example analog magnetic tape, compact disk read only memory (CD-ROM) disks, floppy disks, jump drives, digital cards, multimedia cards, and others. The computer program product may be suitable for loading, by the technical architecture 380, at least portions of the content of the computer program product to the secondary storage 384, to the ROM 386, to the RAM 388, and/or to other non-volatile memory and volatile memory of the technical architecture 380. The processor 382 may process the executable instructions and/or data structures in part by directly accessing the computer program product, for example by reading from a CD-ROM disk inserted into a disk drive peripheral of the technical architecture 380. Alternatively, the processor 382 may process the executable instructions and/or data structures by remotely accessing the computer program product, for example by downloading the executable instructions and/or data structures from a remote server through the network connectivity devices 392.

Whilst the foregoing description has described exemplary embodiments, it will be understood by those skilled in the art that many variations of the embodiment can be made within the scope and spirit of the present invention. For example, the server may be configured to detect the browsing data by receiving time stamps from the client device and perform the assessment of a user's level of interest in the content items using its computational resources to select associated content items. For example, the operations 20-50 as illustrated above may be performed by the server.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable storage medium(s) may be utilized. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device. Furthermore, any program instruction or code that is embodied on such computer readable storage medium (including forms referred to as volatile memory) is, for the avoidance of doubt, considered “non-transitory”.

Program code embodied on a computer readable storage medium may be transmitted using any appropriate medium, including but not limited to wireless, wireline, optical fiber cable, RF, etc., or any suitable combination of the foregoing. Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Features of the present invention may be described with reference to flowchart illustrations and/or block diagrams of methods, apparatus (systems) and computer program products according to embodiments of the invention. It should be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, and/or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored as non-transitory program instructions in a computer readable storage medium that can direct a computer, other programmable data processing apparatus, or other devices to function in a particular manner, such that the program instructions stored in the computer readable storage medium produce an article of manufacture including non-transitory program instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, components and/or groups, but do not preclude the presence or addition of one or more other features, integers, steps, operations, elements, components, and/or groups thereof. The terms “preferably,” “preferred,” “prefer,” “optionally,” “may,” and similar terms are used to indicate that an item, condition or step being referred to is an optional (not required) feature of the invention.

The corresponding structures, materials, acts, and equivalents of all means or steps plus function elements in the claims below are intended to include any structure, material, or act for performing the function in combination with other claimed elements as specifically claimed. The description of the present invention has been presented for purposes of illustration and description, but it is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A computer-implemented method, comprising:
sequentially displaying a plurality of content items on a screen of a display device as a user interacts with a web-browser application;
detecting a display time associated with each content item, wherein the display time is a duration for which the content item is displayed on the screen of the display device; and
determining, for each of the plurality of content items displayed, a level of interest as a function of the display time associated with the content item.

2. The computer-implemented method of claim 1, further comprising:
identifying at least one of the content items that is determined to have a level of interest that exceeds a threshold level; and
selecting an associated content item that is contextually related to the identified content items.

3. The computer-implemented method of claim 2, further comprising:
displaying the associated content item on the screen of the display device in real-time.

4. The computer-implemented method of claim 2, further comprising:
transmitting content data associated with the identified content item to a remote server for selecting the associated content item.

5. The computer-implemented method of claim 4, further comprising:
transmitting the display time associated with each content item to a remote server for determining the level of interest in each content item as a function of the display time associated with the content item.

6. The computer-implemented method of claim 1, further comprising:
identifying a display location of each content item with respect to an interface on which each content item is displayed.

7. The computer-implemented method of claim 6, wherein the interface comprises a plurality of sub-regions, the method further comprising:
identifying one of the sub-regions in which each content item is displayed.

8. The computer-implemented method of claim 6, wherein the interface comprises a graphic user interface of a software application through which the plurality of content items are made available to the user.

9. The computer-implemented method of claim 8, further comprising:
using a graphical control element of the software application to register the location at which the content item is displayed.

10. The computer-implemented method of claim 6, wherein determining, for each of the plurality of content items displayed, a level of interest as a function of the display time associated with the content item, includes calculating an interest score as a function of the display time and the display location.

11. The computer-implemented method of claim 10, wherein calculating the interest score as a function of the display time and the display location, includes obtaining a weight factor associated with a sub-region of the interface where each content item is being displayed.

12. The computer-implemented method of claim 11, wherein calculating the interest score as a function of the display time and the display location, further includes
calculating, for each of the plurality of content items displayed, the interest score as a sum of weighted display times of the content item successively displayed in a plurality of the sub-regions, wherein each weighted display time is equal to the display time of the content item displayed in a sub-region multiplied by the weight factor for the respective sub-region.

13. The computer-implemented method of claim 11, wherein each of the one or more sub-regions are delineated by dividing the interface along one or more lines parallel to a major dimension of the interface.

14. The computer-implemented method of claims 10, further comprising:
identifying a sub-set of the plurality of content items that each have an interest score greater than a reference score, wherein associated content is selected only for the sub-set of the content items.

15. The computer-implemented method of claim 10, further comprising:
determining, for each of the plurality of content items displayed, whether the display time of the content item is greater than a threshold time, wherein an interest score for a content item is calculated only in response to the display time of the content item being greater than the threshold time.

16. The computer-implemented method of claim 1, wherein the plurality of content times are selected from video content, text content, and combinations thereof.

17. The computer-implemented method of claim 1, further comprising:
activating a timer to calculate the display time for the respective content items upon displaying the content items on the screen of the display device.

18. A computer program product comprising a non-transitory computer readable storage medium having program instructions embodied therewith, the program instructions executable by a processor to cause the processor to perform a method comprising:
sequentially displaying a plurality of content items on a screen of a display device as a user interacts with a web-browser application;
detecting a display time associated with each content item, wherein the display time is a duration for which the content item is displayed on the screen of the display device; and
determining, for each of the plurality of content items displayed, a level of interest as a function of the display time associated with the content item.

19. The computer program product of claim 18, the method further comprising:
identifying at least one of the content items that is determined to have a level of interest that exceeds a threshold level;
selecting an associated content item that is contextually related to the identified content items; and
displaying the associated content item on the screen of the display device.

20. The computer program product of claim 19, the method further comprising:
identifying a display location of each content item with respect to an interface on which each content item is displayed, wherein determining, for each of the plurality of content items displayed, a level of interest as a function of the display time associated with the content item, includes calculating an interest score as a function of the display time and the display location.
